(19) United States
(12) Patent Application Publication
(10) Pub. No.: US 2026/0015440 A1
(43) Pub. Date: Jan. 15, 2026

(54) CYCLIC OLEFIN POLYMER HAVING HIGH CIS DOUBLE BOND CONTENT

(71) Applicant: Board of Regents, The University of Texas System, Austin, TX (US)

(72) Inventors: Zachariah A. Page, Austin, TX (US); Adrian Rylski, Austin, TX (US)

(21) Appl. No.: 18/873,981

(22) PCT Filed: May 11, 2023
(86) PCT No.: PCT/US2023/021797

§ 371 Date: Dec. 11, 2024

Related U.S. Application Data
(60) Provisional application No. 63/351,868, filed on Jun. 14, 2022.

(51) Int. Cl. C08F 10/14; C07F 15/00

(52) U.S. Cl. CPC C08F 10/14; C07F 15/0046

(57) ABSTRACT

A cyclic olefin polymer synthesized by ring opening metathesis polymerization (ROMP) has a high cis double bond content. Such polymers can exhibit advantageous mechanical properties. A polymer composite includes a first domain of a polymer having a high cis double bond content and a second domain of a polymer having a high trans double bond content. Methods for the manufacture of high cis content cyclic olefin polymers and composites thereof are also provided.

### CROSS REFERENCE TO RELATED APPLICATION

This application claims priority to U.S. Provisional Patent Application No. 63/351,868, filed Jun. 14, 2022, the contents of which is hereby incorporated by reference in its entirety for all purposes.

### FEDERAL RESEARCH STATEMENT

This invention was made with government support under Grant no. 2045336 awarded by the National Science Foundation. The government has certain rights in the invention.

### BACKGROUND

Living systems have evolved sophisticated structures that synergistically combine stiff and elastic components across molecular to macroscopic length scales. See, e.g., Huang et al., Adv. Mater. 31, 1901561 (2019). This hierarchy gives rise to an unparalleled combination of mechanical properties, including strength, toughness, and durability, that enables survival. See, e.g., Wegst, et al., Nat. Mater. 14, 23-36 (2015); Li, et al., Phys. Rev. E-Stat. Nonlinear, Soft Matter Phys. 84, 1-5 (2011); and Gao, et al., Adv. Mater. 30, 1-8 (2018). A scalable synthetic solution to harnessing biomimetic materials would prove transformative for the medical, automotive, and aerospace industries by providing access to, for example, soft programmable actuators and electronics that interface biotic with abiotic surfaces. However, engineering symbiotic stiff and soft interfaces to harness materials with enhanced bulk mechanical properties remains as an ongoing challenge. See, e.g., Ganewatta, et al., Nat. Rev. Chem. (2021).

Accordingly, it would be advantageous to provide materials with a desirable combination of physical properties. It would further be advantageous to provide materials having well-defined stiff and elastic domains to impart enhanced toughness and durability.

### SUMMARY

An aspect of the present disclosure is a cyclic olefin polymer synthesized by ring opening metathesis polymerization of cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, or a combination thereof, wherein the cyclic olefin polymer has a high cis double bond content.

Another aspect of the present disclosure is a method of making a cyclic olefin polymer having a high cis double bond content, the method comprising: contacting a cyclic olefin monomer comprising cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, norbornene, or a combination thereof, and a stereoregulating metathesis catalyst, under conditions effective to provide the cyclic olefin polymer having a high cis double bond content, wherein contacting the cyclic olefin monomer and the stereoregulating metathesis catalyst is in the presence of less than 1 volume percent of an organic solvent, based on the total volume of the reaction mixture.

Another aspect of the present disclosure is a polymer composite, comprising: a first domain comprising a first polymer synthesized by ring opening metathesis polymerization of cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, norbornene, or a combination thereof, the second polymer having a high cis double bond content; and a second domain comprising a second polymer synthesized by ring opening metathesis polymerization of cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, norbornene, or a combination thereof, the second polymer having a high trans double bond content; optionally wherein the first polymer is coupled to the second polymer at an interface between the first domain and the second domain.

Another aspect of the present disclosure is a method of making the polymer composite, the method comprising: providing a reaction mixture comprising a cyclic olefin monomer, a first stereoregulating metathesis catalyst, a second stereoregulating metathesis catalyst, an activator, and optionally a crosslinker; maintaining a first portion of the reaction mixture in the dark to catalyze polymerization of the cyclic olefin monomer by the first stereoregulating metathesis catalyst to provide the first domain; and exposing a second portion of the reaction mixture to light at a wavelength effective to catalyze polymerization of the cyclic olefin monomer by the second stereoregulating metathesis catalyst to provide the second domain.

The above described and other features are exemplified by the following figures and detailed description.

### BRIEF DESCRIPTION OF THE DRAWINGS

The following figures represent exemplary embodiments.

FIG. 1 shows the design of bioinspired synthetic materials using orthogonal stimuli to pattern crystallinity from a single monomeric feedstock, cis-cyclooctene (COE).

FIG. 2 shows chemical structures for eight representative Ru-alkylidene catalysts (left) examined for ROMP of ˜neat cyclooctene (COE) (top right) to provide trans-polyoctenamer rubber (TOR) or cis-polyoctenamer rubber (COR). Representative 1H NMR spectra for polyoctenamer produced using G2, Ru-3 (+ heat), Ru-3+pyr.+light (Ru-3*), and Ru-5, show the signals corresponding to trans and cis isomers. Insets: trans:cis ratios and representative images of COE and polyoctenamer.

FIG. 3A shows bulk mechanical, optical, and thermal property characterization of TOR and COR. Shown are stress-strain plots from uniaxial tensile testing, with Young's moduli (E) and strain at failure (ε_{f}) values indicated.

FIG. 3B shows images of dogbones used for tensile testing, along with corresponding percent visible light transmittance (T).

FIG. 3C shows differential scanning calorimetry (DSC) to identify melting temperatures and percent crystallinity.

FIG. 4A shows detailed mechanical analyses of cis-polyoctenamer rubber (COR).

Shown is comparison of COR elasticity to natural rubber via hysteresis loss over 500 cycles to 0% load, with inset images of the two materials going from cycle 10 to 11.

FIG. 4B shows representative stress-strain curves for COR and natural rubber used to calculate fracture toughness (G), as defined by the shaded regions, prior crack propagation (symbols are indexed for clarity).

FIG. 4C shows comparison of COR and TOR to several commercially relevant rubbers and plastics as a function of G and modulus.

FIG. 4D shows stress-strain curves for COR prepared with varying amounts of Ru-5 (inset table shows G as a function of [Ru-5]).

FIG. 4E shows strain-induced crystallization for natural rubber and COR as visualized through crossed polarizers.

FIG. 4F shows strain-induced crystallization for natural rubber and COR measured using wide-angle X-ray scattering.

FIG. 5A shows spatiotemporal control over polyoctenamer configuration. Shown is polymerization kinetics of COE with various catalyst systems (note: pyr. is present in all examples containing Ru-5).

FIG. 5B shows an illustration of photopatterning setup.

FIG. 5C shows images of photopatterned TOR and COR using 1951 USAF brightfield and darkfield masks (leftmost pattern are two backlit images of separate films digitally stitched together to concisely show the effect of inverting the majority phase from TOR (left of dash) to COR (right of dash); (i) & (ii) are backlit images taken with a digital microscope to show good pattern fidelity; (iii) relative positions of nanoindentation).

FIG. 5D shows modulus as a function of position across a COR/TOR interface (iii) obtained using nanoindentation.

FIG. 6A shows mechanical characterization including: images of backlit square array with and without crossed polarizers at 0 and 100% strain.

FIG. 6B shows images of a patterned sample during the first and last cycles used for digital image correlation to quantify selective straining.

FIG. 6C shows images of backlit samples between crossed polarizers showing the effect of suture design on strain-stiffening behavior.

FIG. 6D shows corresponding stress-strain curves with labeled positions.

### DETAILED DESCRIPTION

Examples of natural materials including hard and soft interfaces include the semicrystalline morphology of spider silk having improved toughness and resilience, while suture interfaces in shells and skulls improves strength and energy dissipation. See, e.g., Scetta, et al. Macromolecules. 54, 8726-8737 (2021); Simha, et al., J. Mech. Phys. Solids. 51, 209-240 (2003); Zhu, et al., Chinese J. Polym. Sci. (English Ed. (2020), doi:10.1007/s10118-020-2479-6; Narducci, et al., Compos. Sci. Technol. 153, 178-189 (2017); Dimas, et al., Adv. Funct. Mater. 23, 4629-4638 (2013); Ghazlan, et al., Compos. Part B Eng. 205, 108513 (2021); Lin, et al., J. Mech. Phys. Solids. 73, 166-182 (2014); Liu, et al., Acta Biomater. 102, 75-82 (2020). Given the potential for hierarchical hard/soft materials to advance technologies, patterning distinct mechanical properties has become a burgeoning field of research. See, e.g., Barthelat, et al., Nat. Rev. Mater. 1 (2016), doi:10.1038/natrevmats.2016.7. Despite the research efforts in this field, there exists a continuing need for improved materials exhibit improved toughness and durability. It would be advantageous to provide a material which includes 1) tied interfaces to prevent adhesive failure, 2) maximal disparity in stiffness for selective mechanical responses, and 3) elasticity to avoid brittle failure upon bending and stretching. It would be further advantageous to process the material with 1) simplicity and scalability, 2) spatiotemporally controlled chemistry, and 3) minimal material waste.

Existing composites include, for example, those including Al₂O₃/polymethylmethacrylate (e.g., a nacre mimetic) or glass/polyurethane (e.g., a bone mimetic). See, e.g., Mirkhalaf, et al., Nat. Commun. 5, 1-9 (2014); Munch, et al., Science (80), 322, 1516-1520 (2008). However, pervasive adhesive and/or brittle failure of such composites has driven strategies to harness all-polymeric stiff/soft bioinspired materials. See, e.g., Cox, et al., Adv. Eng. Mater. 21, 1900578 (2019); Bialas, et al., Adv. Mater. 31, 1807288 (2019); Dolinski, et al., Adv. Mater. 30, 1800364 (2018); Schwartz, et al., Nat. Commun. 10, 791 (2019); Ma, et al., J. Am. Chem. Soc. 143, 21200-21205 (2021). Existing strategies to alter stiffness rely on spatially varying crosslink density in acrylic-based networks using orthogonal two-stage and/or wavelength-selective lithographic curing processes. Yet, complex designer monomers, expensive fabrication procedures, material failure at low strain, and/or built-in interfacial stress and material waste continue to preclude synthetic materials/structures that mimic those found in nature.

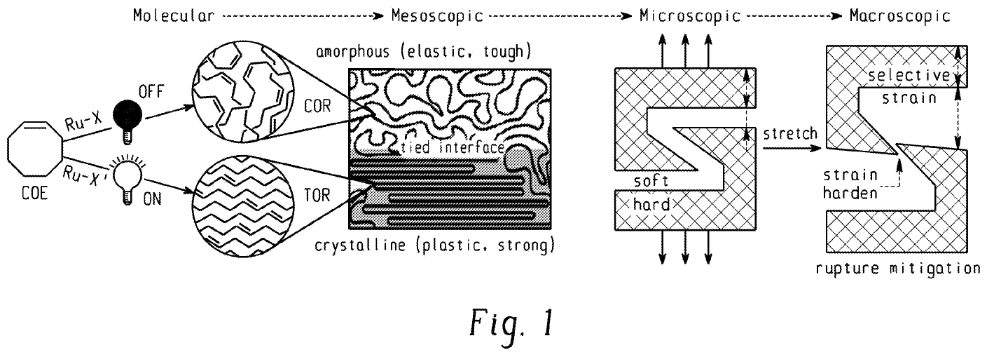

To address the aforementioned technical limitations, the present inventors have discovered a process whereby a material with spatially defined stiff and elastic domains could be realized from a single, inexpensive feedstock. Polyolefins prepared by ring opening metathesis polymerization (ROMP) were selected owing to their versatile material properties and readily available monomer precursors, as evidenced by their industrial utility in automotive parts from tires to body panels. Moreover, the presence of stereogenic centers along the polymer backbone (i.e., C═C double bonds) provides a molecular-level handle to tune bulk material properties from a single monomer. See, e.g., Song, et al., J. Am. Chem. Soc. 142, 10438-10445 (2020); Petersen, et al., Angew. Chemie-Int. Ed. (2022), doi:10.1002/anie.202115904; Stubbs, et al., J. Am. Chem. Soc. 144, 1243-1250 (2022). Notably, ROMP of cis-cyclooctene (COE) has provided trans-polyoctenamer rubber (TOR) with the tradename VESTENAMER™. See, e.g., EVONIK, “The World's Most Versatile Rubber Additive: VESTENAMER” (2022), (available at https://www.vestenamer.com/en/rubber-additive). The high proportion of trans-alkene double bonds (>70%) in TOR leads to a high degree of crystallinity (≥30%) and concomitantly high E (˜500 MPa) and ultimate tensile strength (˜8 MPa), despite having a glass transition temperature far below zero (T_{g}≈−70° C.). From this unique combination of material properties, it is believed that the configurational isomer, cis-polyoctenamer rubber (COR), would reduce the degree of crystallinity and, as a result, provide a soft, elastic material. Furthermore, the present inventors have incorporated photopatterning of such materials to realize bioinspired hierarchical materials with unprecedented bulk mechanical properties (FIG. 1).

Accordingly, an aspect of the present disclosure is a cyclic olefin polymer. As used herein, the term “cyclic olefin polymer” refers to a polymer prepared from a cyclic olefin monomer (e.g., a cyclic aliphatic monomer or a cyclic aromatic monomer having a reactive olefin portion thereof (i.e., forming a portion of the cyclic structure)). The cyclic olefin polymer can be synthesized by ring opening metathesis polymerization (ROMP). More specifically, the cyclic olefin polymer is synthesized by ring opening metathesis polymerization of cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, or a combination thereof. Each of the foregoing monomers may be substituted or unsubstituted, provided that any substituents or functional groups present on the substituents do not interfere with the polymerization. In an aspect, any of the foregoing monomers can be optionally substituted with, for example, a hydroxy group, a C₁₋₁₂ alcohol group, a carboxylic acid group, a C₁₋₁₂ alkyl ether group, an ester group, an amide group, a urethane group, a urea group, an epoxide group, or a combination thereof. In an aspect, the foregoing monomers are unsubstituted.

In an aspect, the cyclic olefin polymer is synthesized by ring opening metathesis polymerization of a cyclic olefin monomer selected from the group consisting of cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, and a combination thereof. In an aspect, the cyclic olefin polymer is synthesized by ring opening metathesis polymerization of a cyclic olefin monomer selected from the group consisting of cis-cyclooctene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, or a combination thereof. In a specific aspect, the cyclic olefin polymer is synthesized by ring opening metathesis polymerization of cis-cyclooctene. The cyclic olefin polymer can be a homopolymer (i.e., derived from a single monomer).

The cyclic olefin polymer has a high cis double bond content. As used here, the term “cis double bond” refers to a carbon-carbon double bond (i.e., C═C) wherein the spatial arrangement of the highest priority groups that are substituted on each carbon of the double bond are positioned on the same side of a plane. Stated another way, the substituent groups of the carbon-carbon double bond are oriented in the same direction. An exemplary “cis double bond” is depicted in the following Formula:

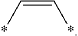

A high cis double bond content can refer to the cyclic olefin polymer having at least 80 mole percent of the double bonds in the cyclic olefin polymer in the cis configuration. Within this range, the cyclic olefin polymer can have a cis double bond content of 80 to 100 mole percent, or 85 to 100 mole percent, or 90 to 100 mole percent, or 95 to 100 mole percent.

Without wishing to be bound by theory, it is believed that the presence of the cis double bonds in the cyclic olefin polymer can cause or contribute to a bend or a “kink” in the polymer chain. Such a bend or “kink” can prevent the cyclic olefin polymer chains from efficiently packing (e.g., tightly packing). Accordingly, the cyclic olefin polymer of the present disclosure can be an amorphous material with a substantially reduced amount of crystalline domains. For example, the cyclic olefin polymer can have a crystallinity of 25% or less, preferably 22% or less. In an aspect, the cyclic olefin polymer can be 0% crystalline (i.e., the cyclic olefin polymer can be amorphous). Percent crystallinity can be determined, for example, using differential scanning calorimetry (DSC).

The cyclic olefin polymer having a high cis double bond content can advantageously exhibit an elasticity that is greater than an elasticity of a corresponding cyclic olefin polymer having a high trans double bond content. As used herein, the term “trans double bond” refers to a carbon-carbon double bond (i.e., C═C) wherein the spatial arrangement of the highest priority groups that are substituted on each carbon of the double bond are positioned on opposite sides of a plane. Stated another way, the substituent groups of the carbon-carbon double bond are oriented in opposite directions. An exemplary “trans double bond” is depicted in the following Formula:

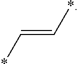

A high trans double bond content can refer to a cyclic olefin polymer having at least 80 mole percent of the double bonds in the cyclic olefin polymer in the trans configuration. Within this range, a cyclic olefin polymer having a high trans double bond content can have a trans double bond content of 80 to 100 mole percent, or 85 to 100 mole percent, or 90 to 100 mole percent, or 95 to 100 mole percent.

In an aspect, a cyclic olefin polymer comprising a poly(cyclooctene) having a cis double bond content of at least 80 mole percent can have an elasticity that is greater than an elasticity of a poly(cyclooctene) having a trans double bond content of at least 80 mole percent when tested under the same testing conditions and having comparable molecular weights.

In an aspect, the cyclic olefin polymer of the present disclosure is not chemically crosslinked. The lack of crosslinking in the cyclic olefin polymer combined with the physical properties (further described below) are expected to contribute to improved recyclability of the present materials relative to prior rubber materials.

The cyclic olefin polymer of the present disclosure can exhibit one or more desirable mechanical properties. For example, a molded sample of the cyclic olefin polymer can exhibit a fracture toughness of greater than 50 KJ/m², preferably greater than 100 KJ/m²; a Young's modulus of 0.5 to 5 MPa, preferably 0.75 to 1.25 MPa; and a strain at break of greater than 500%.

In a specific aspect, the cyclic olefin polymer can be synthesized by ring opening metathesis polymerization of cis-cyclooctene to provide a poly(cyclooctene) having a cis double bond content of 85 to 100 mole percent, or 85 to 99.9 mole percent. A molded sample of the cyclic olefin polymer can exhibit a fracture toughness of greater than 100 KJ/m²; a Young's modulus of 0.75 to 1.25 MPa; and a strain at break of greater than 500%.

In view of the particularly advantageous physical properties for the cyclic olefin polymer of the present disclosure (e.g., a high degree of elasticity), the cyclic olefin polymer having a high cis double bond content can be useful in various articles. Accordingly, an article comprising the cyclic olefin polymer having a high cis double bond content represents another aspect of the present disclosure. Exemplary articles can include, but are not limited to, tires or tire components (e.g., a tread ply skim, body ply skim, bead filler, innerliner, sidewall, stabilizer ply insert, toe filler, chafer, undertread, tread, and the like), gloves, prophylactics, catheters, swimming caps, balloons, tubing, sheeting, packaging materials, o-rings, belts, weather strips, and the like.

Another aspect of the present disclosure is a method of making a cyclic olefin polymer having a high cis double bond content. The method can comprise contacting a cyclic olefin monomer comprising cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, norbornene, or a combination thereof and a stereoregulating metathesis catalyst, for example to provide a reaction mixture.

Contacting the cyclic olefin monomer and the stereoregulating metathesis catalyst can be under conditions effective to provide the cyclic olefin polymer having a high cis double bond content. For example, polymerization of the cyclic olefin monomer in the presence of the stereoregulating metathesis catalyst can be at a temperature of less than 30° C. Within this range, the temperature can be 15 to 30° C., or 15 to 25° C., or 20 to 25° C. In an aspect, the polymerization of the cyclic olefin monomer in the presence of the stereoregulating metathesis catalyst can be for a time of 5 minutes to 5 hours, for example 30 minutes to 2 hours. The polymerization can optionally be in the presence of a particular wavelength of light. For example, in an aspect, the reaction mixture can be exposed to a wavelength of 380 to 500 nanometers, preferably 425 to 475 nanometers. In an aspect, the polymerization can be conducted in the absence of light (i.e., in the dark).

The stereoregulating metathesis catalyst can comprise a stereoretentive metathesis catalyst or a stereoselective metathesis catalyst. As used herein, a stereoretentive catalyst refers to a catalyst that is able to produce a cis or trans double bond in high stereochemical purity (e.g., greater than 90% or greater than 95%) starting from a stereochemically pure cis or trans alkene-containing starting material. Stated another way, the stereochemistry of the double bond of the starting monomer is substantially retained in the polymer product when a stereoretentive catalyst is used (i.e., trans starting materials lead to trans products and cis starting materials lead to cis products). As used herein, a stereoselective catalyst refers to a catalyst that favors the formation of a particular stereochemistry (e.g., cis or trans) and can be independent of the stereochemistry of the starting material configuration.

In an aspect, the stereoregulating metathesis catalyst can comprise a Ru-alkylidene or a W-alkylidene metathesis catalyst, preferably a Ru-alkylidene metathesis catalyst. In a specific aspect, the stereoregulating metathesis catalyst can comprise a Ru-alkylidene metathesis catalyst of Formula (I) or (II)

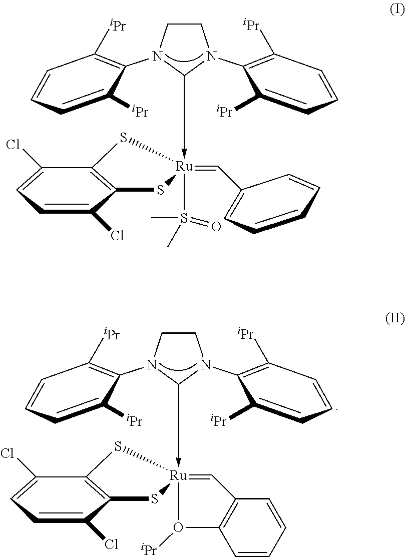

The stereoregulating metathesis catalyst can be present in the reaction mixture in an amount of 0.001 to 10,000 ppm, based on the total weight of the cyclic olefin monomer. Within this range, the stereoregulating metathesis catalyst can be present in the reaction mixture in an amount of 1 to 1000 ppm, or 1 to 100 ppm, or 2 to 50 ppm.

In an advantageous feature, the method of the present disclosure can be conducted in the absence of an organic solvent. For example, contacting the cyclic olefin monomer and the stereoregulating metathesis catalyst can be in the presence of less than 1 volume percent, or less than 0.5 volume percent, or less than 0.1 volume percent of an organic solvent, based on the total volume of the reaction mixture.

Methods for the manufacture of cyclic olefin polymer having a high cis double bond content are further described in the working examples below.

In an aspect, the cyclic olefin polymer described herein can optionally be in the form of a composition further comprising one or more additives. The one or more additives can be selected to achieve a desired property, with the proviso that the additive(s) are also selected so as to not significantly adversely affect a desired property of the cyclic olefin polymer composition. The additive(s) can be mixed with the cyclic olefin polymer to form the composition. The additive(s) can be soluble or non-soluble in the cyclic olefin polymer composition. Exemplary additives can include, but are not limited to, an impact modifier, flow modifier, filler (e.g., a particulate polytetrafluoroethylene (PTFE), glass, carbon, mineral, or metal), reinforcing agent (e.g., glass fibers), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, flame retardant, anti-drip agent (e.g., a PTFE-encapsulated styrene-acrylonitrile copolymer (TSAN)), or a combination thereof. In general, the additives are used in the amounts generally known to be effective. For example, the total amount of the additive composition (other than any impact modifier, filler, or reinforcing agent) can be 0.001 to 10.0 weight percent, or 0.01 to 5 weight percent, each based on the total weight of the cyclic olefin polymer in the composition.

In an aspect, the cyclic olefin copolymer composition can comprise an antioxidant. Antioxidant additives can include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite; alkylated monophenols or polyphenols; alkylated reaction products of polyphenols with dienes, such as tetrakis[methylene(3,5-di-tert-butyl-4-hydroxyhydrocinnamate)]methane; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate; amides of beta-(3,5-di-tert-butyl-4-hydroxyphenyl)-propionic acid, or a combination thereof. Antioxidants, when present, can be used in amounts of 0.01 to 0.1 parts by weight, based on 100 parts by weight of the total composition.

Another aspect of the present disclosure is a polymer composite. The polymer composite comprises a first domain and a second domain. The first domain comprises a first polymer synthesized by ring opening metathesis polymerization of cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, norbornene, or a combination thereof, the second polymer having a high cis double bond content. The second domain comprises a second polymer synthesized by ring opening metathesis polymerization of cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, norbornene, or a combination thereof, the second polymer having a high trans double bond content.

The first polymer can optionally be coupled (i.e., covalently bonded) to the second polymer at an interface between the first domain and the second domain. For example, the first polymer and the second polymer can be covalently bound at the interface of the first domain and the second domain. In some aspects, the first polymer and the second polymer are not coupled (i.e., not covalently bonded) at an interface between the first domain and the second domain.

In an aspect, the first polymer can have a cis double bond content of at least 80 mole percent, preferably 85 to 100 mole percent, more preferably 90 to 100 mole percent. The second polymer can have a trans double bond content of at least 80 mole percent, preferably 85 to 100 mole percent, more preferably 90 to 100 mole percent.

The first domain and the second domain can be present in the composite in a volume ratio of the first domain to the second domain can be 0.1:0.9 to 0.9:0.1. Within this range, the ratio of the first domain to the second domain can be 0.2:0.8 to 0.8:0.2, or 0.3:0.7 or 0.7:0.3, or 0.4:0.6 to 0.6:0.4.

In an aspect, the first domain and the second domain can be arranged in the composite so as to form a regular pattern. Exemplary regular patterns can include, but are not limited to, alternating lines, an anti-trapezoidal pattern, a rectangular pattern, or a combination thereof. In an aspect, the first domain and the second domain can form an irregular pattern, for example wherein the first domain is randomly dispersed throughout the second domain or the second domain is randomly dispersed throughout the first domain.

In an aspect, the polymer composite can have a thickness of 1 micrometer to 10 centimeters. Within this range, the thickness can be, for example, at least 10 micrometers, or at least 50 micrometers, or at least 100 micrometers. Also within this range, the thickness can be at most 5 centimeters, or at most 1 centimeter, or at most 5 millimeters, or at most 1 millimeter. For example, the thickness can be 1 micrometer to 10 centimeters, or 1 micrometer to 5 centimeters, or 1 micrometer to 1 centimeter, or 100 micrometers to 10 centimeters, or 100 micrometers to 5 centimeters, or 100 micrometers to 1 centimeter, or 100 micrometers to 100 millimeters, or 100 micrometers to 10 millimeters, or 100 micrometers to 5 millimeters.

In a specific aspect, the first domain can comprise a poly(cyclooctene) having a cis double bond content of at least 80 mole percent, and the second domain can comprise a poly(cyclooctene) having a trans double bond content of at least 80 mole percent. The first domain can optionally further comprise an additive, as described above.

The polymer composite can be made by a method comprising providing a reaction mixture comprising a cyclic olefin monomer, a first stereoregulating metathesis catalyst, a second stereoregulating metathesis catalyst, an activator, and optionally a crosslinker. The cyclic olefin monomer can be as described above. For example, the cyclic olefin monomer can comprise cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, norbornene, or a combination thereof. In a specific aspect, the cyclic olefin monomer can comprise cis-cyclooctene. The first and second stereoregulating metathesis catalyst can each independently be as described above.

The activator can generally be any photo-oxidant (also referred to as a photo-oxidizing agent). A “photo-oxidant” as used herein refers to a molecule that has photo-oxidation properties, wherein the molecule exhibits an increase in oxidizing potential upon exposure to radiant energy (e.g., light). The term “photo-oxidant” can also refer to a molecule that releases one or more electrons when struck by light.

In an aspect, the activator can comprise a photocatalyst, which can also be referred to as a photoredox catalyst. The terms “photocatalyst” and “photoredox catalyst” are interchangeable and refer to a catalyst that is activated by visible light. “Visible light” as used herein refers to light that has a wavelength of 350 to 750 nm. In an aspect, the visible light can have a wavelength of 350 to 700 nm, 350 to 650 nm, 350 to 600 nm, 350 to 550 nm, 350 to 500 nm, 300 to 450 nm, 300 to 400 nm, 400 to 750 nm, 450 to 750 nm, 500 to 750 nm, 550 to 750 nm, 600 to 750 nm, or 650 to 750 nm. In an aspect, the visible light wavelength can be 400 to 500 nm, 410 to 490 nm, 420 to 450 nm, 430 to 450 nm, or 440 nm. The term “activated by visible light” refers to the state of photoredox catalyst going from unreactive to reactive.

Exemplary activators can include, but are not limited to pyrylium, acridinium, derivatives thereof, salts thereof, and combinations thereof.

In an aspect, the activator can be a photocatalyst, for example as described in U.S. Publication No. 2020/0108381, which is incorporated by reference in its entirety herein. In an aspect, the activator can comprise a photocatalyst of the Formula

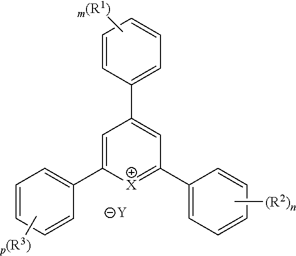

wherein R¹, R², and R³ are independently at each occurrence hydrogen, a halogen, a substituted or unsubstituted C₁₋₁₈ alkyl group, a C₁₋₆ alkoxy group, a cyano group, a nitro group, a C₆₋₂₀ aryl group, a vinyl group, an ester group, an amide group, a ketone group, or a combination thereof. In an aspect, R¹, R², and R³ are independently at each occurrence a C₈₋₁₅ alkyl group, preferably a C₁₂ alkyl group. In the foregoing Formula, m, n, and p is independently at each occurrence 0 to 5, for example 1 to 5. In an aspect, each of m, n, and p is 1. X in the foregoing Formula can be oxygen (O), sulfur(S), selenium (Se), or tellurium (Te). In an aspect, X in the foregoing Formula can be oxygen (O) or sulfur(S). In an aspect, X is O. Y in the foregoing Formula is a counterion. In an aspect, Y can be tetrafluoroborate (BF₄), hexafluorophosphate (PF₆), SbF₆, B₄, ClO₄, a halide, or an anion wherein the conjugate acid has a pKa of less than 4.5. In an aspect, Y is BF₄.

The activator can be present in the reaction mixture in an amount of 1 to 500 ppm based on the total weight of the reaction mixture. Within this range, the activator can be present in an amount of 1 to 250 ppm, or 1 to 100 ppm, or 50 to 100 ppm.

When present, the crosslinker can comprise a molecule comprising at least two double bonds capable of participating in the metathesis polymerization reaction. For example, a crosslinker can comprise a bis(cyclic olefin), for example a bis(cis-cyclooctene). In an aspect, a crosslinker can be present in an amount of less than or equal to 0.5 mole percent, or less than 0.1 mole percent. In an aspect, no crosslinker is present in the reaction mixture.

The method further comprises maintaining a first portion of the reaction mixture in the dark to catalyze polymerization of the cyclic olefin monomer by the first stereoregulating metathesis catalyst to provide the first domain and exposing a second portion of the reaction mixture to light at a wavelength effective to catalyze polymerization of the cyclic olefin monomer by the second stereoregulating metathesis catalyst to provide the second domain. In an aspect, maintaining the first portion in the dark and exposing the second portion to light can be at the same time. In an aspect, maintaining the first portion in the dark and exposing the second portion to light can be accomplished through use of a photomask. The photomask can provide spatial control over the polymerization. The term “photomask” as used herein refers to an object that physically covers particular regions of the reaction mixture. The photomask is preferably opaque to visible like (e.g., the photomask is black or made of a material that reflects visible light). The photomask further comprises one or more openings that permit the light to be applied to particular regions of the reaction mixture. The final polymer composite is a completely metathesized product. Stated another way, polymerization occurs in both the exposed and unexposed regions of the reaction mixture, however the particular conditions of each region of the reaction mixture provide a product with spatially controlled stereoselectivity (e.g., cis and trans polymer regions).

The polymer composite can be prepared at a temperature of less than 30° C. Within this range, the temperature can be 15 to 30° C., or 15 to 25° C., or 20 to 25° C.

A particular wavelength of light can be used to catalyze polymerization of the second domain. In an aspect, the wavelength effective to catalyze polymerization of the cyclic olefin monomer can be 380 to 500 nanometers, preferably 425 to 475 nanometers. It will be understood that other wavelengths can be used, and can be appropriately selected depending on, for example, the identity of the stereoregulating catalyst and the cyclic olefin monomer.

Methods for the manufacture of the polymer composite are further described in the working examples below.

This disclosure is further illustrated by the following examples, which are non-limiting.

### Examples

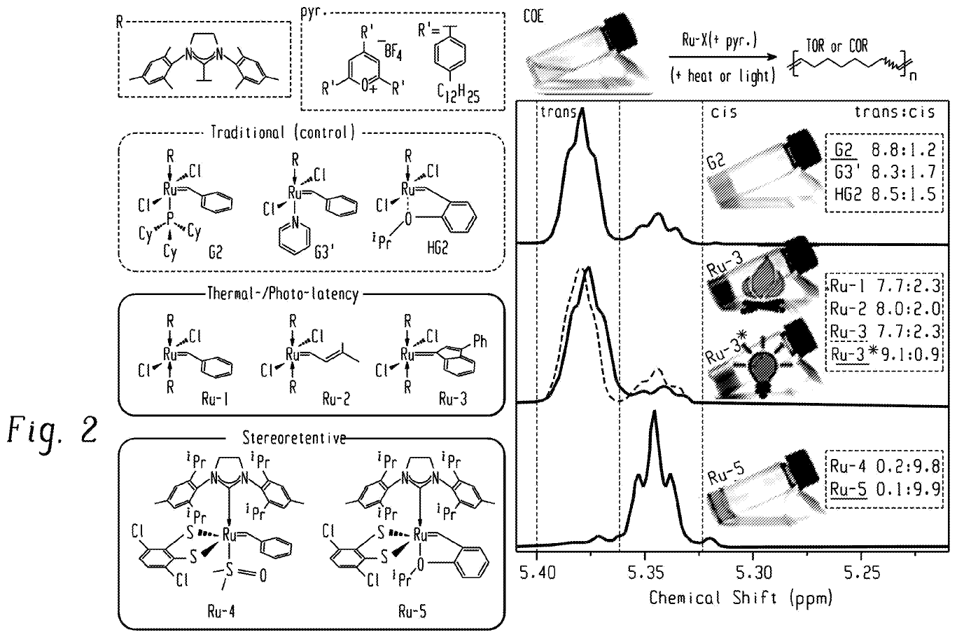

Eight exemplary metathesis catalysts, shown in FIG. 2, were screened to determine their relative reactivity and stereochemical regulation of the resultant polyoctenamer double bond. The low viscosity nature of COE enabled polymerizations to be performed under near neat conditions (>99 volume percent (vol %) COE, based on the total volume of the reaction mixture), minimizing the use of hazardous solvents during processing (e.g., <1 vol % anisole present for catalyst dissolution and injection). The trans:cis alkene ratio was characterized using nuclear magnetic resonance (NMR) spectroscopy, integrating the peaks around 5.35 ppm. The first three catalysts examined were traditional Grubbs catalyst 2^{nd} (G2) and modified 3^{rd} (G3′) generations and Hoveyda-Grubbs catalyst 2^{nd} generation (HG2), which all contained a single N-heterocyclic carbene (NHC) ligand. Upon catalyst addition (50 ppm relative to monomer), ROMP completed within minutes at room temperature, providing ˜85% trans-alkene isomers (i.e., TOR). Subsequently, bis-NHC catalysts shown to be thermally latent were examined to facilitate room temperature processing followed by stimulus-activation (e.g., heat or light). Specifically, the bis-NHC catalysts contained a benzylidene (Ru-1), alkenylcarbene (Ru-2), or indenylidene (Ru-3) complex. Adding these catalysts to COE at room temperature and applying heat (100° C.) gave TOR with ˜78% trans content.

Towards the eventual realization of spatial control over ROMP it was desirable to replace thermal-latency with photo-latency. The three bis-NHC derivatives were examined for photo-latent ROMP of substantially neat COE. A COE-soluble pyrilium (pyr.) derivative was synthesized and evaluated, namely 2,4,6-tris(4-dodecylphenyl)pyrylium tetrafluoroborate, as shown in FIG. 2 (“pyr.”). Latency for COE mixtures containing bis-NHC catalysts (50 ppm) and pyr. (75 ppm) was first tested by measuring monomer conversion after keeping samples in the dark for one hour at room temperature. Under these conditions, only Ru-3 showed latency, with ˜1% conversion of COE, while the others showed near quantitative COE consumption within one hour, though at a slower rate compared to G2, G3′, and HG2. Without wishing to be bound by theory, the reduced reactivity (i.e., increased stability) of Ru-3 in the dark relative to Ru-1 and Ru-2 likely arises from greater steric hindrance and electron donation of the indenylidene relative to benzylidene and alkenylcarbene complexes. Irradiating, Ru-3+pyr. in COE with a blue LED (˜460 nm, 170 mW/cm²) for 5 minutes at room temperature resulted in near-quantitative monomer consumption, indicating excellent temporal control with the present photosystem, termed Ru-3*, as shown in FIG. 2. Furthermore, this process provided TOR with a trans content of 91%, a modest increase relative to that obtained via thermal-activation (78% trans), hypothesized to arise from improved thermodynamic control at room temperature.

Stereoregulation of ROMP to yield polymers with high cis-alkene content has recently been accomplished through the use of stereoselective and stereoretentive catalysts. See, e.g., Song, et al., J. Am. Chem. Soc. 142, 10438-10445 (2020); Müller, et al., Beilstein J. Org. Chem. 14 (2018), pp. 2999-3010; Grandner, et al., J. Org. Chem. 82, 10595-10600 (2017); Kempel, et al., Synlett (2021), doi:10.1055/a-1352-1605; Endo, et al., J. Am. Chem. Soc. 133, 8525-8527 (2011). However, there remains a continuing need to expand the monomer scope amenable to stereoregulated ROMP, and provide new high cis-alkene content materials.

In the present work, four commercial stereoregulating catalysts were screened: two stereoselective Koji catalysts (Endo, et al., J. Am. Chem. Soc. 133, 8525-8527 (2011)) and two stereoretentive catalysts, Ru-4 and Ru-5, bearing bulky dithiolate ligands. The stereoselective catalysts were unable to reach high conversions of COE, even at elevated temperatures for extended reaction times (<30%, 100° C., 18 hours). In contrast, the stereoretentive catalysts, Ru-4 and Ru-5, proved effective at reaching high conversions of COE (>99%) in under two hours at room temperature, while providing COR with a cis content of ˜99%. Further examples employed Ru-5 due to its improved stability relative to Ru-4, imparted by the oxygen-chelate. Thus, precise control over the backbone double bond configuration of polyoctenamer was possible using mild (latent) conditions.

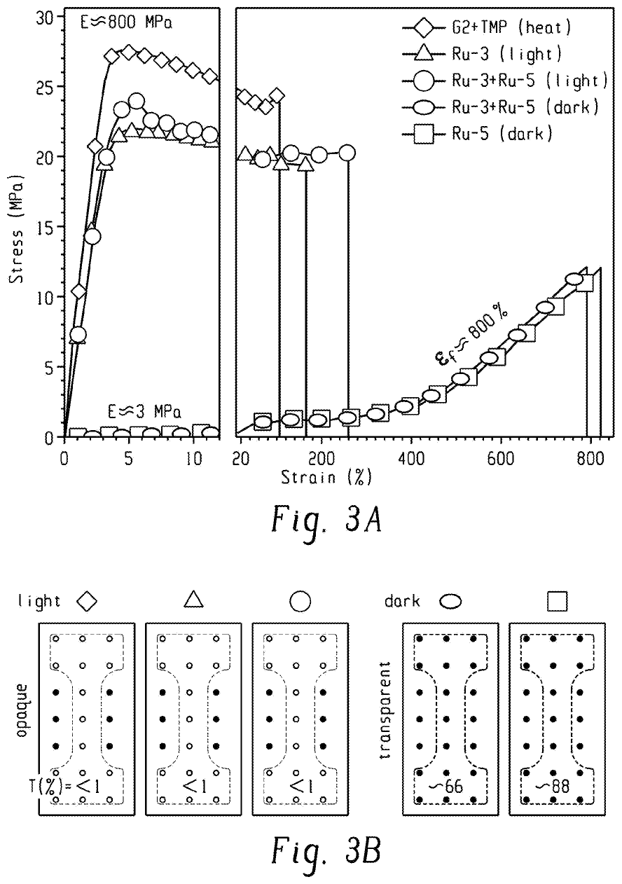

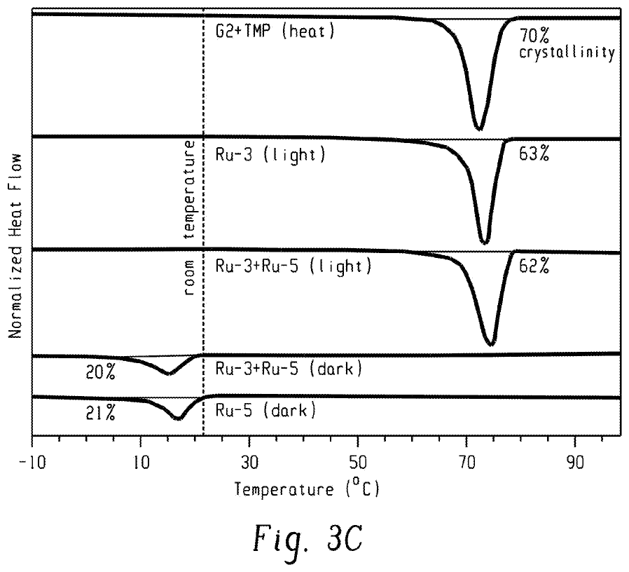

Upon producing TOR and COR, observable distinctions were immediately evident in both their look and feel; TOR was hard and opaque, while COR was soft and transparent. Tensile testing was used to quantify the difference in mechanical properties imparted by backbone configuration. Films of TOR and COR were prepared by casting solutions of COE with selected catalysts between two glass plates separated by 250 μm spacers. Post-polymerization, the films were separated from the glass and dried for at least 10 hours under vacuum at 50° C. Samples were stamped from the sheets (e.g., according to ASTM D-1708) and uniaxial tension was applied (20 mm/min) until failure, as shown in FIG. 3A. Five different mixtures that provided TOR and COR were analyzed: 1) G2 (50 ppm) with trimethyl phosphite (50 ppm) to facilitate thermally-latent casting (80° C., 1 hr), 2) Ru-3 (50 ppm) and pyr. (75 ppm) with blue light irradiation (˜460 nm, ˜170 mW/cm², 5 min), 3) Ru-5 (20 ppm, room temperature, 1 hr), and 4) Ru-3 (50 ppm), pyr. (75 ppm), and Ru-5 (20 ppm) with (5 min) or 5) without (60 min) light exposure. The conditions that produced TOR (1, 2, and 4) all provided a strong and stiff plastic, with max stress (Om) values of ˜23-27 MPa and Young's moduli (E) of ˜800-1000 MPa. In contrast, conditions that produced COR (3 and 5) provided a soft and stretchable elastomer, with E≈3 MPa, strain at failure (ε_{f}) of ˜800%, and σₘ≈12 MPa. Furthermore, Shore A hardness evaluation gave 89 and 59 units for TOR and COR, respectively, comparable to commercial plastics and elastomers. These results are summarized in Table 1.

TABLE 1

| | | | | Cis content | Crystallinity | | | |
|---|---|---|---|---|---|---|---|---|
| Ex. | Ru Catalyst | Additive | Condition | (%) | (%) | σₘ (MPa) | E (MPa) | ε_{f} (%) |
| 1 | G2 | TMP | 80° C., 1 hr¹ | 12%² | 70 | 26.5 ± | 582.6 ± | 144.5 ± |
| | (50 ppm) | (50 ppm) | | | | 0.4 | 19.3 | 49.8 |
| 2 | Ru-3 | Pyr | 460 nm, 170 | 9% | 63 | 23.4 ± | 613.3 ± | 19.0 ± |
| | (50 ppm) | (75 ppm) | mW/cm², 5 min | | | 0.7 | 28.2 | 6.9 |
| 3 | Ru-5 | — | Room temp., | 99% | 21 | 10.3 ± | 3.1 ± | 785.0 ± |
| | (20 ppm) | | 1 hr (dark) | | | 1.0 | 0.1 | 8.27 |
| 4 | Ru-3 (50 ppm); | Pyr | 460 nm, 170 | 43% | 62 | 22.9 ± | 714.175 ± | 338.6 ± |
| | Ru-5 (20 ppm) | (75 ppm) | mW/cm², 5 min | | | 2.0 | 94.8 | 29.5 |
| 5 | Ru-3 (50 ppm); | Pyr | Room temp., | 99% | 20 | 10.7 ± | 3.0 ± | 834.5 ± |
| | Ru-5 (20 ppm) | (75 ppm) | 1 hr (dark) | | | 2.6 | 0.4 | 80.8 |

¹Conditions used to prepare samples for mechanical testing;
²Cis content determined on sample prepared using G2 at room temperature for 18 hours

Thus, it was shown that mechanical properties could be dramatically tuned for the Ru-3 and Ru-5 blended catalyst system by simply toggling visible LED irradiation to dictate backbone stereochemistry.

Backbone stereochemistry was hypothesized to influence solid-state packing, and specifically crystallization as indicated by a notable difference in opacity between TOR (opaque) and COR (transparent), as quantified by visible light transmittance measurements (FIG. 3B). Differential scanning calorimetry (DSC) was used to characterize the melting temperature (Tₘ) and degree of crystallinity for both COR and TOR (FIG. 3C). Using a modulated heat ramp, Tₘ values of ˜72° C. and ˜16° C. were observed for TOR and COR, respectively. The degree of crystallinity was then calculated by integrating the change in enthalpy vs “100%” crystalline polyoctenamer (216 J/g). (Schneider, et al., J. Mol. Catal. 46, 395-403 (1988)). In this manner, TOR was 62-70% crystalline, and COR was 20-21% crystalline, albeit, below room temperature, which is in-line with the previously noted elastomeric mechanical response under ambient conditions. The glass transition temperature (T_{g}) for TOR and COR was found to be around −80° C., matching prior reports for TOR. Overall, optical and thermal analyses suggest that macroscopic crystallization dictates bulk mechanical properties, which can be tailored through visible light exposure of a single COE resin containing ppm levels of Ru-3 and Ru-5.

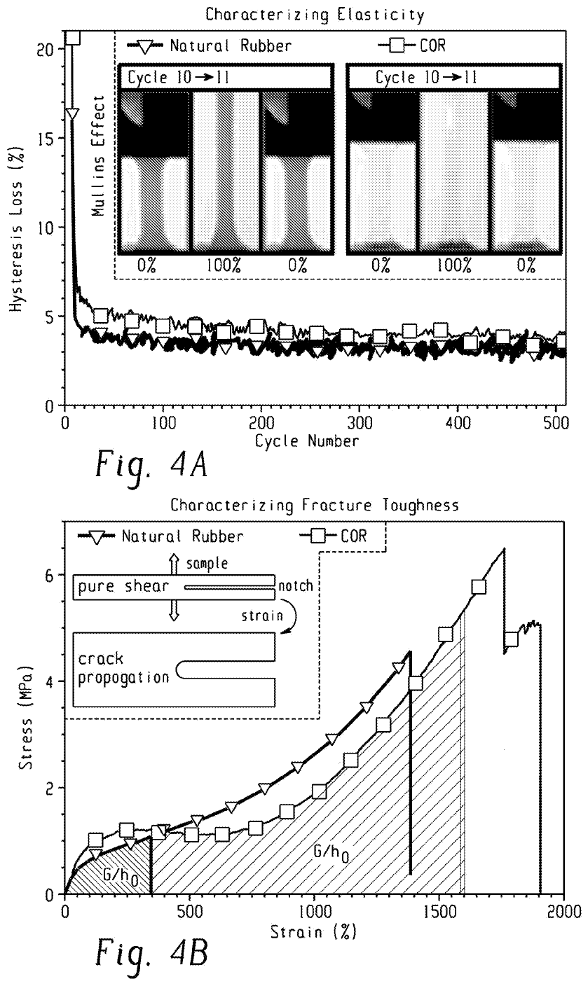

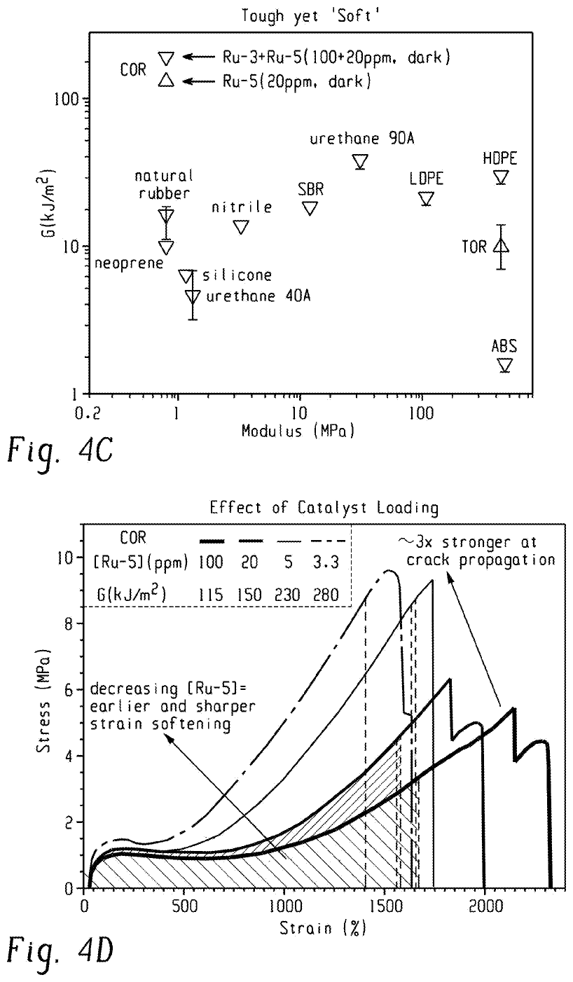

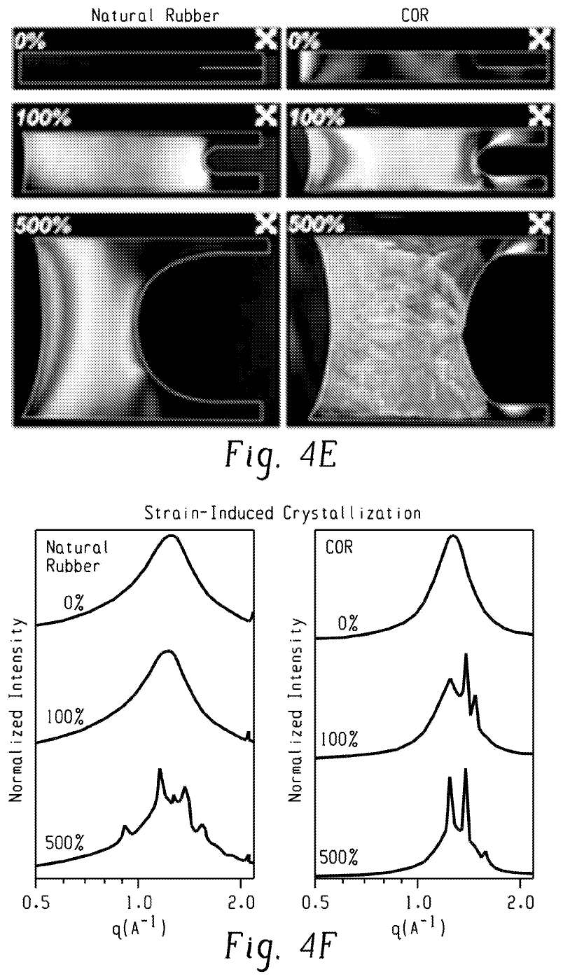

A hallmark of many industrially relevant rubbers is their excellent reversible elasticity (i.e., low hysteresis), which facilitates iterative loading and unloading cycles without causing permanent (i.e., plastic) deformation or failure. Performing hysteresis analysis to 100% strain revealed very comparable behavior between COR and natural rubber over 500 cycles (returning to 0% load), as shown in FIG. 4A. Each material equilibrated to a small, ˜4% hysteresis loss, post-Mullins effect. Notably, the stress-strain curves for COR show yielding and necking behavior at moderate strain (>200%, FIG. 3A), common to plastics and not rubbers. However, many applications, such as bioelectronics, operate to a maximum strain of ˜100%. Thus, COR may find utility in such applications owing to its competitively low hysteresis compared to natural rubber as a gold standard.

In working with COR, it was qualitatively noted that it was difficult to break, even in the presence of defects (e.g., cracks and voids). This observation prompted the characterization of fracture toughness, or the amount of energy needed for a crack to propagate. As a benchmark, several commercially relevant tough rubbers (e.g., natural rubber, polyurethane 40A, polyurethane 90A, SBR rubber, neoprene, silicone, and nitrile) and plastics (e.g., HDPE, LDPE, and ABS) were characterized under identical conditions. Using a pure shear geometry (40×5 mm2 gauge), samples with and without a ˜10 mm notch were prepared and tested under uniaxial tension at a constant strain rate (20 mm/min). Strain energy release rate (i.e., fracture toughness) was obtained following the method described by Rivlin and Thomas (Rivlin, et al., J. Polym. Sci. 10, 291-318 (1953)), with G(λ)=W_{PS}(λ)h₀; where G(λ) is the strain energy release rate as a function of displacement λ, W_{PS}(λ) is the energy density as a function of λ, and h₀ is the initial sample height (FIG. 4B). Notably, COR was more than an order of magnitude tougher (G=150±40 KJ/m² from 20 ppm Ru-5 and G=190±38 kJ/m² from 20 ppm Ru-5±50 ppm Ru-3, no irradiation) compared to all other commercial rubbers with a similarly low E (<10 MPa), including natural rubber (G=15±5 KJ/m²) known for its uniquely high toughness (FIG. 4C). For stiffer commercial samples, the toughest was urethane 90A (G=37±3 KJ/m², E=30 MPa), still ˜4×less tough than COR. In comparison, TOR had a toughness (G=10±3 KJ/m²) in-between other stiff plastics (E≥400 MPa), including ABS (G=1.6±0.2 kJ/m²) and HDPE (G=28±2 kJ/m²). Thus, COR demonstrated unprecedented toughness, particularly considering its low E and hysteresis, a useful combination for applications requiring stretchable materials at ‘soft/hard’ (biotic/abiotic) interfaces (e.g., bioelectronics).

To better understand the mechanism underpinning the remarkable toughness of COR, several criteria were further examined. First, the effect of catalyst loading was tested based upon the hypothesis that lower catalyst loading would result in increased molecular weight and, congruently, entanglements, thereby increasing toughness. Varying Ru-5 catalyst loading from 100 ppm to 3.3 ppm (≈26 ug/g COE) resulted in a >2× increase in toughness (G=115±14 kJ/m² to 280±17 KJ/m²) (FIG. 4D). Lowering [Ru-5] to 2 ppm resulted in a decrease in toughness. The enhanced toughness arises from an earlier and sharper strain-stiffening without compromising the large strain required to induce crack propagation, at which point samples prepared with 3.3 ppm Ru-5 loading have a ˜3×larger strength relative to those from 100 ppm Ru-5. Although, molecular weight could not be characterized by traditional size exclusion chromatography due to poor solubility, rheological analysis of COR showed an increase in viscosity as catalyst loading was decreased, pointing towards an increase in molecular weight, and thus increased molecular entanglements. Moreover, the preparation of lightly covalently crosslinked COR resulted in a drastic decrease in toughness (G=19±13 KJ/m² and 1.1±0.7 kJ/m² at 0.1 and 0.5 mol % crosslinker, respectively), further supporting the notion that entanglements (physical crosslinks) are required for the high toughness.

To ascertain whether mechanisms outside entanglement density were contributing to enhanced toughness, apparent stress-strain distributions were visualized via birefringence that arises from chain-alignment during uniaxial tensile testing. Backlit samples were placed between crossed polarizers and optical anisotropy was recorded for natural rubber and COR in a pure shear geometry (FIG. 4E). At low strains, both natural rubber and COR show a localized high-stress field at the blunted crack-tip, but COR introduces a unique behavior at larger displacements, where the stress-field distributes throughout the bulk of the sample. In what visually appears to be polydomain crystallization, notched COR samples essentially ‘forget’ the existence of the crack defect. To characterize the postulated crystallization, wide-angle X-ray scattering (WAXS) was performed on non-notched and notched samples at 0, 100, and 500% strain at room temperature (FIG. 4F). At 0% strain, non-notched COR (and natural rubber) appeared completely amorphous, consistent with DSC (FIG. 3C, Tₘ≈16° C.). Upon stretching to 100% strain, sharp peaks indicative of crystallization appeared for COR (but not natural rubber), which became more apparent at 500% strain. Using Natta's method to quantify the “absolute” percent crystallinity, COR was ˜20% at 500% strain, while natural rubber was ˜10% at 500% strain. Thus, COR uniquely disperses strain energy through crystallization as a mechanism to increase fracture toughness.

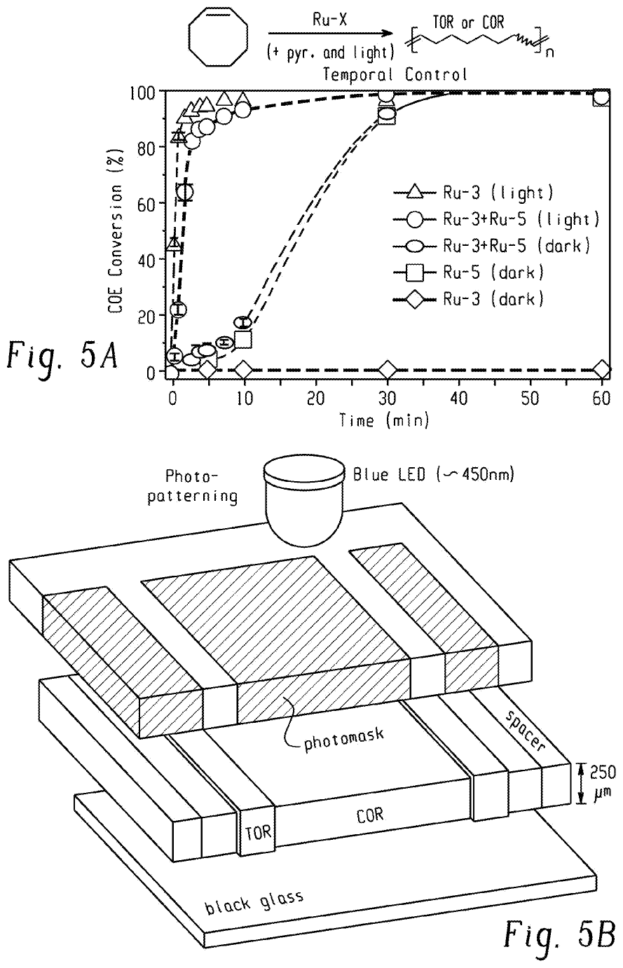

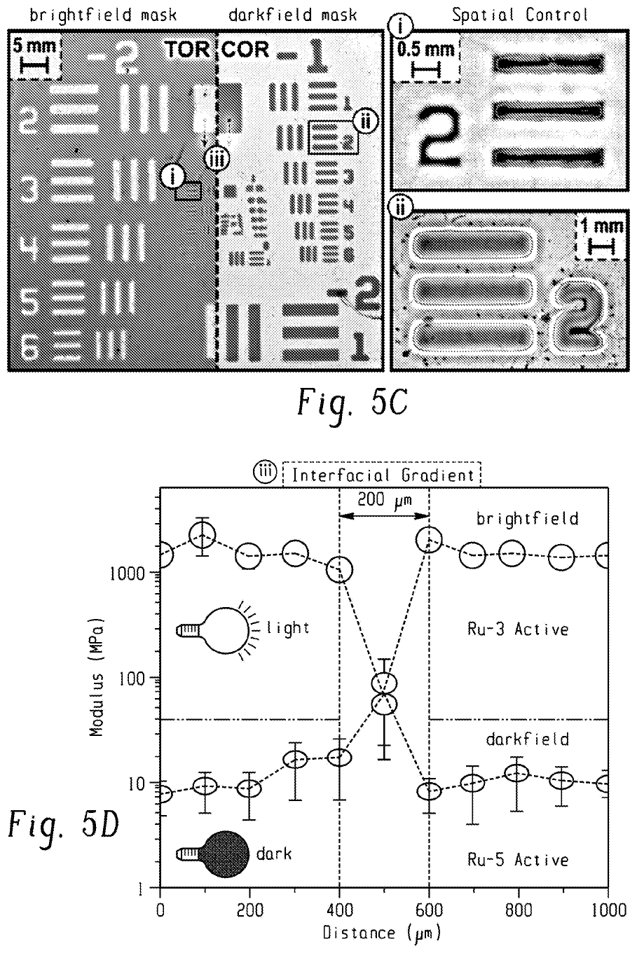

NMR spectroscopy was selected to characterize ROMP kinetics for different catalyst systems by removing and testing aliquots over the course of 60 minutes (FIG. 5A). Blue light irradiation (˜460 nm, ˜170 mW/cm²) of a mixed catalyst system comprising Ru-3 (50 ppm+75 ppm pyr.) and Ru-5 (20 ppm) resulted in ˜90% conversion of COE to TOR in ˜5 minutes, comparable to the control without Ru-5 present. Moreover, in the absence of Ru-5 and light, little-to-no polymerization of COE was observed. In contrast, the mixed catalyst system in the dark resulted in relatively slow COR formation, <10% conversion of COE in ˜5 minutes. However ROMP to COR proceeded steadily in the dark, reaching near-quantitative conversion of COE in ˜60 minutes, comparable to the control without Ru-3 and pyr. present. These distinct differences in light vs dark ROMP kinetics were anticipated to enable photopatterning of semicrystalline TOR in a matrix of rubbery COR.

Next, a method was designed to pattern TOR in COR. Resin containing the aforementioned mixed catalyst system in COE was loaded under inert gas between a photomask and black glass, separated by 250 μm shims, followed by irradiation with blue light for 5 minutes (FIG. 5B). Pattern fidelity was characterized using both brightfield and darkfield 1951 USAF masks, which define resolution as the smallest discernable line pair (lp) (FIG. 5C). The resolution for brightfield (majority TOR) and darkfield (majority COR) were found to be ˜9.0 lp/mm (˜55 μm) and ˜1.3 lp/mm (˜400 μm), respectively. The difference in resolution was hypothesized to arise from outward crystal growth beyond exposure areas, which resulted in compressed and expanded features under brightfield (FIG. 5Ci) and darkfield (FIG. 5Cii) conditions, respectively. An additional measure of resolution was accomplished at a TOR/COR interface (FIG. 5Ciii) was nanoindentation, which revealed a E gradient of ˜200 μm, while also confirming a two orders of magnitude difference in E; ˜ 1000 MPa to ˜10 MPa for TOR to COR, respectively (FIG. 5D). Furthermore, it was demonstrated that photoROMP could be used to create thick TOR samples with a trans-alkene content of ˜80% up to ˜4 mm. Thus, compositionally uniform films (polyoctenamer) with high resolution patterning of crystallinity (TOR) in a rubbery matrix (COR) is possible using the present system.

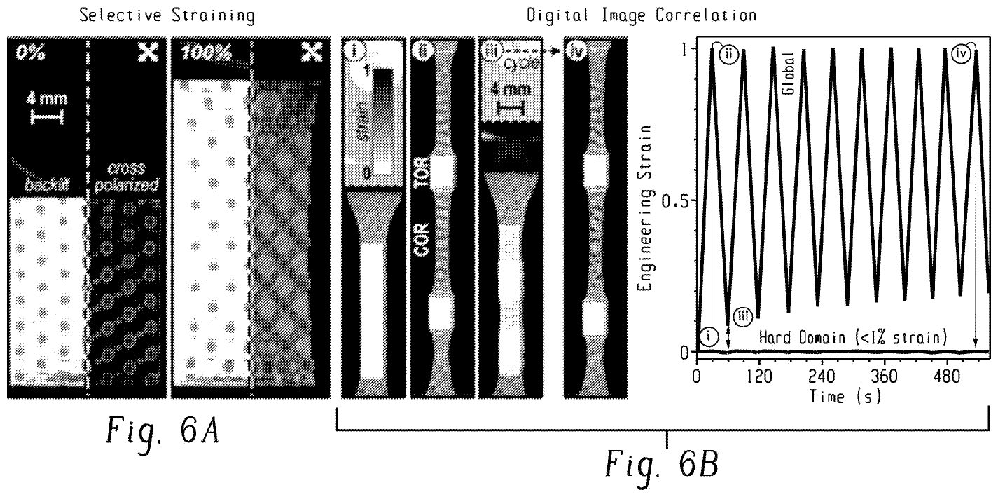

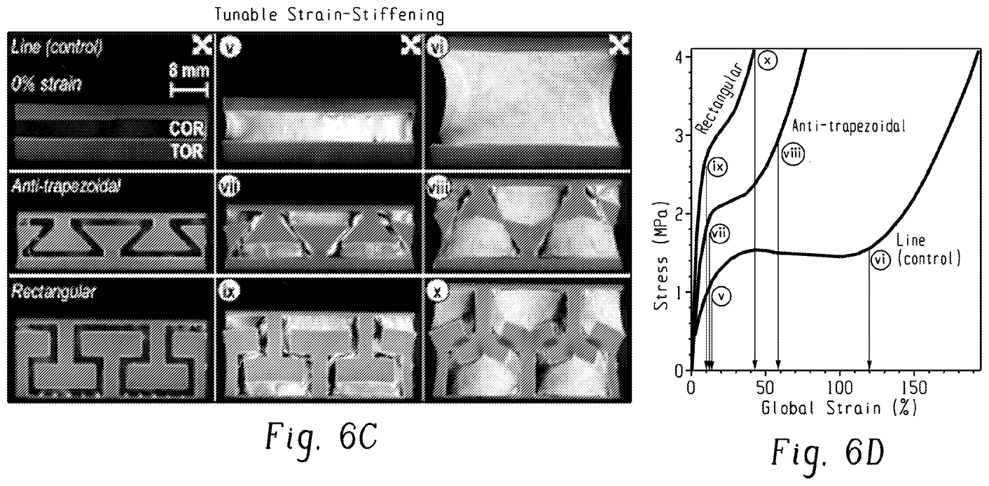

As a final proof of concept, patterns were designed to display the ability of the present platform to access unusual bulk mechanical behaviors (i.e., metamaterials) that require synergy between stiff and compliant domains (FIG. 6). First, selective straining was demonstrated with a square array (1 mm diameter) of TOR patterned into a continuous COR matrix, a construct with potential utility in stretchable electronics. Cycling to 100% strain qualitatively showed that strain, and congruently stress, were localized to COR domains, as visualized for backlit samples with and without crossed polarizers (FIG. 6A). Quantification of this behavior was accomplished using digital image correlation (DIC) analysis on a sample containing 5 mm wide lines, revealing that the stiff TOR domains strain <1% relative to bulk (FIG. 6B). Thus, patterned TOR domains have the potential to act as support structures for brittle (electronic) components on overall stretchable devices. Moreover, the lack of interfacial failure upon application of significant global stress (>4 MPa) suggests strongly interwoven domains, which, without wishing to bound by theory, may result from a combination of physical entanglements between TOR and COR and/or continuity of TOR/COR polymer backbones that could arise from cross-metathesis.

Subsequently, bioinspired sutures were examined as a means to control strain-stiffening behavior, a common mechanism used by natural tissue to prevent rupture (FIG. 6C). Three patterns with approximately equal COR:TOR (0.35:0.65) ratios were prepared and characterized by uniaxial tension between crossed polarizers. A straight line control and anti-trapezoidal and rectangular sutures all showed stress and strain localized to regions of COR. Distinct strain-stiffening behavior appeared for the sutures as regions of TOR approached each other, causing deformations and concomitant stress increases at strains unique to the specific suture design (FIG. 6D). Thus, photopatterning of polyoctenamer configuration enables the bulk preparation of bioinspired mechanical metamaterials.

Accordingly, the present disclosure describes a simple and scalable synthetic procedure to prepare hierarchical materials with stiff (TOR) and elastic (COR) domains, emulating those found in nature. Specifically, a mixed catalyst system sensitive to visible light enables ROMP of COE with spatiotemporal control over the resultant polyoctenamer backbone cis/trans stereochemistry. As a result, polyolefins with an unprecedented combination of fracture toughness, elasticity, and tunable moduli across two orders of magnitude can be patterned with microscopic precision. This novel platform provides access to advanced materials with broad ranging applications, from flexible electronics to soft robotics.

Experimental details follow.

Materials and methods. All reagents were used as received, unless otherwise stated. 4-Bromobenzaldehyde >99.6% was purchased from Chem-Impex. 4′-bromoacetophenone 98% was purchased from Alfa Aesar. Hexanes (certified ACS), dichloromethane (CH₂Cl₂) (certified ACS), ethanol (EtOH) (certified ACS), methanol (MeOH) (certified ACS), potassium hydroxide (KOH) (certified ACS), sodium hydroxide (NaOH) (certified ACS), sodium bicarbonate (certified ACS), and magnesium sulfate anhydrous (certified ACS) were purchased from Fisher Scientific. Para-toluenesulfonic acid monohydrate ≥99% was purchased from MP Biomedicals. Diethyl ether (certified ACS), ethylene glycol 99.8% (anhydrous), 1-bromododecane 98%, 3-Chloroperoxybenzoic acid 70-75%, sodium hydride 60%, 1-6,dibromohexane, 98% and cis-cyclooctene stabilized ≥95% were purchased from ACROS organics. Cis-cyclooctene was further purified with short-path distillation onto molecular sieves (4 Å) and stored under nitrogen. Tert-butyllithium solution (1.6 M in pentane), 1-5 cyclooctadiene, lithium aluminum hydride 95%, anisole anhydrous 99.7%, and 4-tert-butylbenzaldehyde 97% were purchased from Sigma-Aldrich. 4-tert-butylacetophenone 95% was purchased from Matrix Scientific. Boron trifluoride diethyl etherate 98% was purchased from Oakwood Chemical. Ethyl vinyl ether stabilized with KOH 98.0+% and α, α′-Dibromo-p-xylene were purchased form TCI. Metathesis Catalysts: M102, M202, M320, M720, M800, M801, M802, M2001, M2002, M2102, and M3002 were obtained from Umicore. CDCl₃ 99.8% and CD₂Cl₂ 99.8% were purchased from Cambridge Isotope Laboratories. Anhydrous tetrahydrofuran (THF), anhydrous methylene chloride (DCM), and anhydrous toluene were obtained from a Vac solvent purification system prior to their use.

Nuclear Magnetic Resonance (NMR) Spectroscopy: NMR spectra were recorded on an Agilent MR 400 MHz spectrometer utilizing CDCl₃ or CD₂Cl₂ as the solvent. 1H NMR were carried out coupled and referenced to the CDCl₃ chemical shift or CD₂Cl₂ chemical shift at 7.26 ppm and 5.30 ppm respectively. ¹³C NMR were carried out decoupled and referenced to the CDCl₃ chemical shift or CD₂Cl₂ chemical shift at 77.16 ppm and 53.52 ppm respectively. Data reported as multiplicity (s=singlet, d=doublet, t=triplet, q=quartet, m=multiplet).

High Resolution Mass Spectrometry (HRMS): HRMS was performed on an Agilent Technologies 6530 Accurate-Mass Q-TOF LC/MS using APCI or ESI and the data was subsequently analyzed using Agilent MassHunterQualitative Analysis Software.

UV-Visible Absorption Spectroscopy (UV-vis) and Transmittance Measurements: UV-vis was performed on a horizontal transmission accessory (Stage RTL-T, Ocean Optics) connected to a spectrometer (QE PRO-ABS, Ocean Optics) through optical fibers. A deuterium-tungsten halogen light sources (DH-2000-BAL) was used as the probe light. Tuned for absorption measurements, this system utilizes a balanced deuterium-tungsten halogen light source (DH-2000-BAL) with a typical output of 194 μW (deuterium bulb) and 615 μW (tungsten bulb) through an SMA 905 connector, covering a range from 230 nm-2.5 μm. Multimode fiber-optic cables with SMA connectors on both ends and a 600 μm core diameter (QP600-025-SR) connect the light source to the sample holder. For dilute solution measurements a qpod cuvette holder (QNW qpod 2eTM) capable of magnetic stirring and peltier-driven temperature control from −30° C. to 105° C. is used. For thin-film absorption measurements a reflection-transmission sample stage from Ocean Insight (STAGE-RTL-T) is used. The sample holder is coupled through another multimode fiber to the spectrometer (QEPRO-ABS) having an entrance slit of 5 μm (INTSMA-005 Interchangeable Slit). The spectrometer measures in the range from 200-950 nm, at an optical resolution of 1.7 nm, using a back-thinned, TE cooled, 1024×58 element CCD array. Transmittance measurements were performed directly with the polymer film using Ocean Optics software.

Glovebox and Solvent Purification System: A VAC OMNI-LAB glovebox was used for air and water free chemistry. The gloveboxes are under a nitrogen atmosphere with oxygen levels kept below 5 ppm and water below 0.5 ppm. Oxygen levels are monitored using an electrolytic fuel cell sensor (VAC 102237) and water levels with Aluminum oxide probe (VAC 108669). Solvent removal is facilitated with activated carbon (VAC 102287). Each box is equipped with a −35° C. freezer (VAC 100595). Antechambers for sample transfer use an Edwards RV12 A65514906 rotary vane pump (10 cfm at 60 Hz, ultimate pressure of 1.5×10-3 Torr). One glovebox is connected to a solvent purification system (VAC 103991), which enables delivery of dry solvents directly into the box.

Gel Permeation Chromatography (GPC): GPC was performed on a Tosoh EcoSEC HLC-8320GPC System equipped with a series of TSKgel SuperMultiporeHZ-H, -M, and -N columns. The instrument was equipped with a refractive index (RI) and ultraviolet (UV) absorbance detector (UV-8320). The instrument was run with HPLC-grade tetrahydrofuran as the eluent and toluene as an internal standard, at a flowrate of 0.300 mL/min, temperature of 40° C., and injection volume of 50-100 μL. Prior to injection, all samples were fully dissolved in the mobile phase at a concentration of ˜1-5 mg/mL and passed through a 0.45 μm syringe filter. Molecular weight and molecular weight distributions for the samples were estimated using a calibration curve generated from poly(methyl methacrylate) standards.

Sample irradiation for film casting was performed with a LightBox. LightBox was developed by Monoprinter and contains a 460 nm LED array with a 24V 350W internal power supply. At a setting of 200 pwm, with the diffuser installed, the light intensity was measured to be ˜ 160 mW/cm².

Tensile testing was carried out using a Shimatzu Autograph AGS-X universal testing machine equipped with a 10 kN load cell. Samples were cut using an ASTM Standard D-1708 dogbone punch (5 mm width, 20 mm gauge length) from networks approximately 250 μm in thickness. Samples were dried overnight in a vacuum oven 50° C. overnight prior to testing. Axial extension was carried out at 20 mm/min (100% strain/min) until fracture.

Thermogravimetric analysis (TGA) was performed on a TA Instruments TGA Q500 with a heat ramp set at 5.00° C./min with a range starting at 25° C. and ending at 600° C.

Differential scanning calorimetry (DSC) was performed using TA Instruments DSC2500 with a modulated heat only method ramping at 3.00° C./min with a range starting at −90° C. and ending at 200° C. Data was collected from the films as cast to describe the crystallinity obtained from polymerization.

Wide-angle X-ray scattering (WAXS) measurements of strained COR and natural rubber were performed using a Xenocs Ganesha small angle scattering instrument with a Dectris 300k detector. The instrument was equipped with a microfocus CuKα source and was operated at 50 kV and 0.6 mA. SAXSGUI (Rigaku Innovative Technologies, Inc. and JJ X-ray Systems ApS), a manufacturer supplied software utility, was used to provide corrections and to convert 2-D detector data into intensities as a function of scattering angle. Percent crystallinity was estimated using a gaussian fit of the combined amorphous and crystalline peaks.

Rheology experiments were performed on a TA Instruments Discovery Hybrid Rheometer (HR2). The 8.0 mm parallel plate was used with the stainless-steel Peltier plate and a gap of 230 μm to be confident of contact with the ˜250 μm test specimen. A flow-sweep was performed at 25° C. with a logarithmic sweep from 1.0 e⁻⁴ 1/s to 1000 l/s collecting 5 points per decade with steady sensing turned on. The maximum equilibration time was 120.0 s with a sample period of 10.0 s.

Microscopy images were taken using a Keyence Model VHX 5000 microscope.

Nanoindentation measurements were carried out across a TOR-COR interface using a Hysitron TI 950 TriboIndenter. Samples were loaded to a maximum force of 500 uN and unloaded without any dwell time. Modulus was calculated by the Hysitron software by fitting a slope to the unloading force-displacment curve.

Dynamic Mechanical Analysis (DMA): Glass transition temperatures were measured a TA Instruments Q800 DMA in the tensile geometry. Sample geometry 8×20×0.25 mm was used. Samples were tested at a frequency of 1 Hz with a heating rate of 3° C./min. A heat-cool-heat process was used (25° C. to 150° C. to −100° C. to 150° C.) and the glass transitions obtained from the final heat step are reported, taken as the temperature corresponding to the local peaks in tan (delta).

Synthesis of Film Networks: Inside the glovebox, oven-dried one-dram vials were loaded with cyclooctene, crosslinker, and metathesis catalyst. The vials were mixed with a vortex mixer and loaded between two glass slides separated with spacers on each side (image 1). Glass slides were pre-placed on a flat surface or the lightbox prior to loading the mixed formulation. For curing of the photolatent metathesis catalysts and irradiation time of five minutes was used with an intensity of ˜170 mW/cm². Following adequate cure time, the glass plates were removed from the glovebox and the films were separated from between the glass plates. Films were dried in a vacuum oven at 50° C. overnight prior to mechanical analysis.

Casting of Photolatent and Patterned Film Networks: Outside the glovebox a solution of pyrylium catalyst, of known concentration, was prepared using DCM, and loaded into an oven-dried one-dram vial to contain 1.56 mg of pyrylium catalyst. This was dried at 70° C. overnight and stored in the glovebox afterwards. Inside the glovebox, to the vial containing pyrylium, 3 mL of cyclooctene was loaded. In a separate oven-dried one-dram vial metathesis catalyst was weighed and diluted to 50 mM with anisole. To the vial of monomer and pyrylium, the necessary amount of catalyst(s) were loaded and the vial was mixed with a vortex mixer. After mixing the vial was left undisturbed for 20-60 seconds to settle remaining air bubbles. The mixed resin was loaded between two glass sheets (or photomask as the bottom sheet, and black glass as the top sheet), via glass syringe, separated by plastic spacers of known thickness on each side. Glass slides were pre-placed on the LightBox, prior to loading the mixed formulation. For curing the lightbox was set to an irradiation time of five minutes with an intensity of ˜170 mW/cm². Following adequate cure time (˜2 hours), the glass plates were removed from the glovebox and the films were placed in a −80° C. freezer to assist in separation from the glass. After separation, films were dried in a vacuum oven at 50° C. overnight prior to mechanical analysis.

Hysteresis measurements were carried out using a Shimatzu Autograph AGS-X universal testing machine equipped with a 10 kN load cell. Samples were cut using an ASTM Standard D-1708 punch (5 mm width, 20 mm gauge length) from films approximately 250 μm in thickness. Hysteresis experiments were carried out at 20 mm/min and involved cycling to 100% strain with zero force in between each cycle to reduce the applied strain.

Digital image correlation: A specimen was first fully painted with a layer of white silicone spray paint. After the white paint completely dried (˜ 15 minutes), speckles of black spray paint were painted onto it. Upon completely drying, the sample was cut into a custom dog bone shape and manually clamped into a tensile tester (Instron 34TM5) which had a 100 Newton load cell. The cyclic test was done at 1 mm/sec (an initial strain rate of 0.031). The specimen was loaded to an engineering strain of 1 then unloaded until no force was exerted by the specimen. This was repeated 10 times. Images were captured of the specimen every second for a Digital Image Correlation analysis. Using a modified version of PyDIC (https://gitlab.com/damien.andre/pydic), digital image correlation was performed on the cyclic test images. An area of interest within the specimen was chosen and a grid of points 15 pixels apart within the area of interest was formed. For each point, a window of 30×30 pixels, with the point being in the center, was formed. The window (and thus the point) was tracked and updated on each consecutive image. The engineering strain is determined by the gradient at each point. Due to the horizontal symmetry of the sample, the strains were averaged along the y direction. To prevent blending the distinct border between the hard and soft domains, no smoothing was performed along the x direction. The strain in the hard segments was determined by averaging 14 horizontally averaged points, 7 in each hard segment. This approximates to 3 mm sections within each of the 5 mm hard segments.

Toughness characterization was carried out using a Shimatzu Autograph AGS-X universal testing machine equipped with a 10 kN load cell. Samples were cut using a rectangular punch (40 mm width, 20 mm height) from films. Notched specimen had a ˜10 mm cut made with a fresh razor blade down the axial plane to the edge of the specimen. Samples were loaded so that the gauge area was 40 mm width, and 5 mm height. Axial extension was carried out at 20 mm/min until fracture. The fracture toughness (G) analysis was performed through taking the obtained stress-strain curves for at least three notched and three unnotched specimen and analyzing the continued crack propagation in the notched specimen from the decrease in stress and evaluating fracture toughness against all three of the unnotched specimen.

This disclosure further encompasses the following aspects.

Aspect 1: A cyclic olefin polymer synthesized by ring opening metathesis polymerization of cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, or a combination thereof, wherein the cyclic olefin polymer has a high cis double bond content.

Aspect 2: The cyclic olefin polymer of aspect 1, wherein the cyclic olefin polymer has a cis double bond content of at least 80 mole percent, preferably 85 to 100 mole percent, more preferably 90 to 100 mole percent.

Aspect 3: The cyclic olefin polymer of aspect 1 or 2, wherein a molded sample of the cyclic olefin polymer exhibits an elasticity that is greater than an elasticity of a corresponding cyclic olefin polymer having a high trans double bond content, preferably a trans double bond content of at least 80 mole percent.

Aspect 4: The cyclic olefin polymer of any of aspects 1 to 3, synthesized by ring opening metathesis polymerization of cis-cyclooctene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, or a combination thereof.

Aspect 5: The cyclic olefin polymer of any of aspects 1 to 4, synthesized by ring opening metathesis polymerization of cis-cyclooctene.

Aspect 6: The cyclic olefin polymer of any of aspects 1 to 5, wherein the cyclic olefin polymer is not chemically crosslinked.

Aspect 7: The cyclic olefin polymer of any of aspects 1 to 6, wherein the cyclic olefin polymer wherein a molded sample of the cyclic olefin polymer exhibits a fracture toughness of greater than 50 KJ/m², preferably greater than 100 KJ/m²; a Young's modulus of 0.5 to 5 MPa, preferably 0.75 to 1.25 MPa; and a strain at break of greater than 500%.

Aspect 8: The cyclic olefin polymer of any of aspects 1 to 7, synthesized by ring opening metathesis polymerization of cis-cyclooctene, wherein the cyclic olefin polymer has a cis double bond content of 85 to 99.9%; and wherein the cyclic olefin polymer wherein a molded sample of the cyclic olefin polymer exhibits a fracture toughness of greater than 100 KJ/m²; a Young's modulus of 0.75 to 1.25 MPa; and a strain at break of greater than 500%.

Aspect 9: A method of making a cyclic olefin polymer having a high cis double bond content, the method comprising: contacting a cyclic olefin monomer comprising cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, norbornene, or a combination thereof, and a stereoregulating metathesis catalyst, under conditions effective to provide the cyclic olefin polymer having a high cis double bond content, wherein contacting the cyclic olefin monomer and the stereoregulating metathesis catalyst is in the presence of less than 1 volume percent of an organic solvent, based on the total volume of the reaction mixture.

Aspect 10: The method of aspect 9, wherein polymerization of the cyclic olefin monomer is at a temperature of less than 30° C., preferably 20 to 25° C.

Aspect 11: The method of aspect 9 or 10, wherein the stereoregulating metathesis catalyst comprises a Ru-alkylidene or a W-alkylidene metathesis catalyst.

Aspect 12: The method of any of aspects 9 to 11, wherein the stereoregulating metathesis catalyst is a stereoretentive or stereoselective metathesis catalyst.

Aspect 13: The method of any of aspects 9 to 12, wherein the stereoregulating metathesis catalyst comprises a Ru-alkylidene.

Aspect 14: The method of any of aspects 9 to 13, wherein the steroregulating metathesis catalyst comprises a Ru-alkylidene metathesis catalyst of Formula (I) or (II)

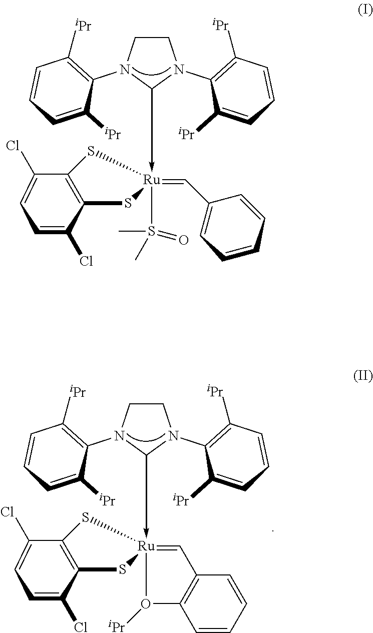

Aspect 15: The method of any of aspects 9 to 14, wherein the stereoregulating metathesis catalyst is present in an amount of 0.001 to 10,000 ppm, or 1 to 1000 ppm, or 1 to 100 ppm, or 2 to 50 ppm, each based on the total weight of the cyclic olefin monomer.

Aspect 16: A polymer composite, comprising: a first domain comprising a first polymer synthesized by ring opening metathesis polymerization of cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, norbornene, or a combination thereof, the second polymer having a high cis double bond content; and a second domain comprising a second polymer synthesized by ring opening metathesis polymerization of cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, norbornene, or a combination thereof, the second polymer having a high trans double bond content; optionally, wherein the first polymer is coupled to the second polymer at an interface between the first domain and the second domain.

Aspect 17: The polymer composite of aspect 16, wherein the first polymer has a cis double bond content of at least 80 mole percent, preferably 85 to 100 mole percent, more preferably 90 to 100 mole percent, and the second polymer has a trans double bond content of at least 80 mole percent, preferably 85 to 100 mole percent, more preferably 90 to 100 mole percent.

Aspect 18: The polymer composite of aspect 16 or 17, wherein the first polymer and the second polymer are covalently bound at the interface of the first domain and the second domain.

Aspect 19: The polymer composite of any of aspects 16 to 18, wherein a volume ratio of the first domain to the second domain is 0.1:0.9 to 0.9:0.1, or 0.2:0.8 to 0.8:0.2, or 0.3:0.7 or 0.7:0.3, or 0.4:0.6 to 0.6:0.4.

Aspect 20: The polymer composite of any of aspects 16 to 19, wherein the first domain and the second domain form a regular pattern, preferably wherein the regular pattern comprises alternating lines, an anti-trapezoidal pattern, a rectangular pattern, or a combination thereof.

Aspect 21: The polymer composite of any of aspects 16 to 20, wherein the polymer composite has a thickness of 1 micrometer to 10 centimeters, or 1 micrometer to 5 centimeters, or 1 micrometer to 1 centimeter, or 100 micrometers to 10 centimeters, or 100 micrometers to 5 centimeters, or 100 micrometers to 1 centimeter, or 100 micrometers to 100 millimeters, or 100 micrometers to 10 millimeters, or 100 micrometers to 5 millimeters.

Aspect 22: The polymer composite of any of aspects 16 to 21, wherein the first domain comprises poly(cyclooctene) having a cis double bond content of at least 80 mole percent, and the second domain comprises poly(cyclooctene) having a trans double bond content of at least 80 mole percent.

Aspect 23: A method of making the polymer composite of any of aspects 16 to 22, the method comprising: providing a reaction mixture comprising a cyclic olefin monomer, a first stereoregulating metathesis catalyst, a second stereoregulating metathesis catalyst, an activator, and optionally a crosslinker; maintaining a first portion of the reaction mixture in the dark to catalyze polymerization of the cyclic olefin monomer by the first stereoregulating metathesis catalyst to provide the first domain; and exposing a second portion of the reaction mixture to light at a wavelength effective to catalyze polymerization of the cyclic olefin monomer by the second stereoregulating metathesis catalyst to provide the second domain.

Aspect 24: The method of aspect 23, wherein polymerization of the cyclic olefin is at a temperature of less than 30° C., preferably 20 to 25° C.

Aspect 25: The method of aspect 23 or 24, wherein the wavelength effective to catalyze polymerization of the cyclic olefin monomer is 350 to 800 nanometers, preferably 380 to 500 nanometers, more preferably 425 to 475 nanometers.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC—CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

Unless substituents are otherwise specifically indicated, each of the foregoing groups can be unsubstituted or substituted, provided that the substitution does not significantly adversely affect synthesis, stability, or use of the compound. “Substituted” means that the compound, group, or atom is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkylene (e.g., benzyl), C₇₋₁₂ alkylarylene (e.g, toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the substituted atom's normal valence is not exceeded, and that the substitution does not significantly adversely affect the manufacture, stability, or desired property of the compound. When a compound is substituted, the indicated number of carbon atoms is the total number of carbon atoms in the compound or group, including those of any substituents.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A cyclic olefin polymer synthesized by ring opening metathesis polymerization of cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, or a combination thereof, wherein the cyclic olefin polymer has a cis double bond content of at least 80 mole percent, based on the total moles of cyclic olefin polymer.

2. The cyclic olefin polymer of claim 1, wherein the cyclic olefin polymer has a cis double bond content of 85 to 100 mole percent, based on the total moles of cyclic olefin polymer.

3. The cyclic olefin polymer of claim 1, wherein a molded sample of the cyclic olefin polymer exhibits an elasticity that is greater than an elasticity of a corresponding cyclic olefin polymer having a high trans double bond content.

4. The cyclic olefin polymer of claim 1, synthesized by ring opening metathesis polymerization of cis-cyclooctene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, or a combination thereof.

5. The cyclic olefin polymer of claim 1, synthesized by ring opening metathesis polymerization of cis-cyclooctene.

6. The cyclic olefin polymer of claim 1, wherein the cyclic olefin polymer is not chemically crosslinked.

7. The cyclic olefin polymer of claim 1, wherein a molded sample of the cyclic olefin polymer exhibits a
fracture toughness of greater than 50 KJ/m²;
a Young's modulus of 0.5 to 5 MPa; and
a strain at break of greater than 500%.

8. The cyclic olefin polymer of claim 1, synthesized by ring opening metathesis polymerization of cis-cyclooctene,
wherein the cyclic olefin polymer has a cis double bond content of 85 to 99.9%; and
wherein a molded sample of the cyclic olefin polymer exhibits
a fracture toughness of greater than 100 KJ/m²;
a Young's modulus of 0.75 to 1.25 MPa; and
a strain at break of greater than 500%.

9. A method of making a cyclic olefin polymer having a high cis double bond content, the method comprising:
contacting
a cyclic olefin monomer comprising cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, norbornene, or a combination thereof, and
a stereoregulating metathesis catalyst,
to provide the cyclic olefin polymer having a cis double bond content of at least 80 mole percent,
wherein contacting the cyclic olefin monomer and the stereoregulating metathesis catalyst is in the presence of less than 1 volume percent of an organic solvent, based on the total volume of the reaction mixture.

10. The method of claim 9, wherein polymerization of the cyclic olefin monomer is at a temperature of less than 30° C.

11. The method of claim 9, wherein the stereoregulating metathesis catalyst comprises a Ru-alkylidene or a W-alkylidene metathesis catalyst.

12. The method of claim 9, wherein the stereoregulating metathesis catalyst is a stereoretentive or stereoselective metathesis catalyst and wherein the stereoregulating methathesis is present in an amount of 0.001 to 10,000 pp, based on the total weight of the cyclic olefin monomer.

13. (canceled)

14. The method of claim 9, wherein the steroregulating metathesis catalyst comprises a Ru-alkylidene metathesis catalyst of Formula (I) or (II)

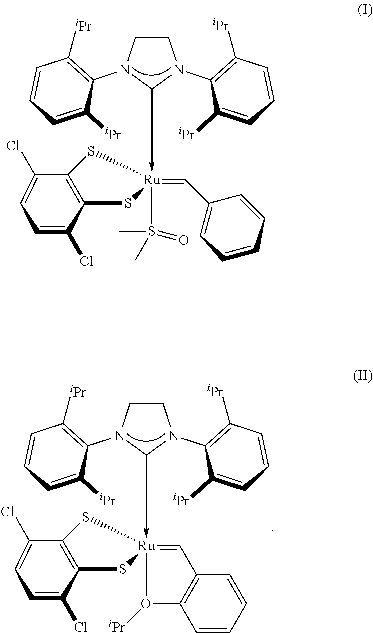

15. (canceled)

16. A polymer composite, comprising:
a first domain comprising a first polymer synthesized by ring opening metathesis polymerization of cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, norbornene, or a combination thereof, the first polymer having a high cis double bond content; and
a second domain comprising a second polymer synthesized by ring opening metathesis polymerization of cis-cyclooctene, cis-cyclooctadiene, trans-cyclooctene, cis-cyclodecene, trans-cyclodecene, cis-cyclononene, trans-cyclononene, cis-cycloheptene, cis-cyclohexene, cis-cyclopentene, cis-cyclobutene, cis-cyclopropene, norbornene, or a combination thereof, the second polymer having a high trans double bond content;
optionally, wherein the first polymer is coupled to the second polymer at an interface between the first domain and the second domain.

17. The polymer composite of claim 16, wherein
the first polymer has a cis double bond content of at least 80 mole percent, and
the second polymer has a trans double bond content of at least 80 mole percent.

18. The polymer composite of claim 16, wherein the first polymer and the second polymer are covalently bound at the interface of the first domain and the second domain.

19. The polymer composite of claim 16, wherein a volume ratio of the first domain to the second domain is 0.1:0.9 to 0.9:0.1.

20. The polymer composite of claim 16, wherein the first domain and the second domain form a regular pattern.

21. (canceled)

22. The polymer composite of claim 16, wherein
the first domain comprises poly(cyclooctene) having a cis double bond content of at least 80 mole percent, and
the second domain comprises poly(cyclooctene) having a trans double bond content of at least 80 mole percent.

23. A method of making the polymer composite of claim 16, the method comprising:
providing a reaction mixture comprising a cyclic olefin monomer, a first stereoregulating metathesis catalyst, a second stereoregulating metathesis catalyst, an activator, and optionally a crosslinker;
maintaining a first portion of the reaction mixture in the dark to catalyze polymerization of the cyclic olefin monomer by the first stereoregulating metathesis catalyst to provide the first domain; and
exposing a second portion of the reaction mixture to light at a wavelength effective to catalyze polymerization of the cyclic olefin monomer by the second stereoregulating metathesis catalyst to provide the second domain.

24. (canceled)

25. (canceled)
